(19) United States
(12) Patent Application Publication
(10) Pub. No.: US 2011/0315227 A1
(43) Pub. Date: Dec. 29, 2011

(54) MICROFLUIDIC SYSTEM AND METHOD

(76) Inventor: Wenmiao Shu, Edinburgh (GB)

(21) Appl. No.: 13/141,500

(22) PCT Filed: Dec. 24, 2009
(86) PCT No.: PCT/GB2009/002968

§ 371 Date: Sep. 12, 2011

(30) Foreign Application Priority Data
Dec. 24, 2008 (GB) 0823510.3
Sep. 2, 2009 (GB) 0915276.0

(51) Int. Cl. F15D 1/00; B01L 3/00

(52) U.S. Cl. 137/1; 422/502

(57) ABSTRACT

A microfluidic system comprises a detachable microfluidic device comprising a rigid layer, an elastic layer and at least one fluid chamber or channel between the rigid layer and the elastic layer; and a control platform comprising means for de-forming the elastic layer thereby to manipulate fluid in the at least one fluid chamber or channel.

### FIELD OF THE INVENTION

The present invention relates to microfluidic devices, for example microfluidic devices that are constructed to contain fluids (for any conceivable purpose), and to methods or systems for manipulating fluids that are contained within such devices. The present invention relates, for example, to apparatus and methods for manipulation of fluids in a microfluidic device, including pumps, valves and mixers and ‘lab-on-a-chip’ devices and techniques.

### BACKGROUND TO THE INVENTION

There are several known approaches to providing control and manipulation of fluid flow and fluid dynamics in microfluidic devices. The system chosen to control and manipulate fluids can be continuous (for example, fluid in the system is maintained in a continuous conduit), or non-continuous (for example, fluid in the system is maintained in discrete units, usually droplets).

The design of microfluidic manipulation systems is dependent on the system of fluid manipulation. Continuous systems are typically controlled by valves, pumps and mixers (for example, microactuators and microvalves), while non-continuous systems are typically controlled by electrical, optical, or other manipulation of the substrate material (for example, electro- and opto-wetting).

Thermal regulation of fluid dynamics, and modification of wetting properties of surfaces using electric fields or using light/lasers have been demonstrated as means to control fluid flow and dynamics in microfluidic devices. However the most commonly used approach in continuous microfluidic devices is the fabrication of microscopic pumps and valves based on micro-servomechanisms, the properties and substrate materials of which vary substantially with design and the control of which is typically enabled by application of an electric current, or by magnetism or temperature.

An unresolved issue in the art of microfluidics is the provision of fluid manipulation systems with minimal complexity of design and fabrication, which may enable low-cost manufacturing and disposability of the devices.

WO02068849 describes an electrically-controlled microactuator fabricated from a water-permeable membrane consisting of a polymer that distorts its shape in a controlled, predictable fashion upon application of electrical current, and can thereby be used as a microvalve and/or micropump. However, similar to the majority of existing microfluidic manipulation systems, the system described in WO02068849 involves the fabrication of the necessary microcomponents (for example microelectrodes, microactuators, micromembranes) directly onto the microfluidic device, in order to enable control and manipulation within the device. This strategy of embedding the active components for microfluidic manipulation inherently increases the complexity of design and fabrication, keeping manufacturing costs high, and generally making the device unsuitable for many disposable applications, particularly life sciences applications.

WO0229106 describes a system comprising cross-linked multilayer channels that control flow via deformable channels for use in microfluidic manipulation. The system involves the use of networks of over-laid elastic polymer (elastomers) channels to control and manipulate fluid flow in a device. Microfluidic flow is controlled by deforming one elastomeric channel overlying another by pressurization of the channel (with gas or liquid), and thereby providing microvalve and/or micropump functions. However, the system of WO0229106 is dependent on complex microfluidic network design, and precise alignment of multilayer channels embedded within the device to achieve control, and is therefore relatively difficult to manufacture.

It is an aim of the invention to provide an improved, or at least alternative, microfluidic system, device and/or method.

### SUMMARY OF THE INVENTION

In a first, independent aspect of the invention there is provided a microfluidic system comprising a detachable microfluidic device comprising a rigid layer, an elastic layer and at least one fluid chamber or channel between the rigid layer and the elastic layer; and a control platform comprising means for deforming the elastic layer thereby to manipulate fluid in the at least one fluid chamber or channel.

By providing a control platform and a detachable microfluidic device, a system that is particularly simple to manufacture can be provided. The elastic layer may provide an interface that enables the manipulation of fluid in the at least one fluid chamber or channel using devices external of the microfluidic device, provided for example on the control platform.

Electronic, electromechanical, optical or other complex control or measurement components can be provided on the control platform rather than on the microfluidic device, reducing the complexity of manufacture of the microfluidic device. The microfluidic device may be manufactured using low cost materials and fabrication processes, and may be treated as disposable.

The manipulation of fluid in the at least one fluid chamber of channel may include, for example, controlling fluid flow or other fluid dynamics. Fluid flow may be flow along a chamber or channel or fluid flow within a chamber or channel.

A microfluidic system or device may be for example a system or device for manipulation of fluids on the millimetre or sub-millimetre scale, for example a system or device that includes at least one fluid chamber or channel at least part of which has at least one dimension that is less than or equal to around 1 mm.

The rigid layer is usually sufficiently rigid that if the rigid layer is held stationary, a force applied to the elastic layer causes a deformation of the elastic layer relative to the rigid layer. The rigid layer may be substantially rigid in whole or part. The rigid layer may comprise a plurality of sub-layers or components. The rigid layer may for example comprise a substantially rigid portion (for example a substantially rigid frame) and a flexible portion fixed to the substantially rigid portion.

The microfluidic device and the detachable control platform may be coupleable in at least one alignment position, in which the means for deforming the elastic layer is operable to selectively deform at least one selected part of the elastic layer.

Thus, fluid may be manipulated at selected parts of the microfluidic device.

The at least one selected part of the elastic layer may comprise at least one part of the elastic layer at which deformation of the elastic layer causes operation of a microfluidic control component of the microfluidic device.

The microfluidic control component may comprise a valve, mixer, or pump.

The microfluidic device and the control platform may be coupleable in a plurality of different alignment positions, and in each alignment position deformation of the elastic layer may cause operation of a respective at least one microfluidic control component of the microfluidic device.

Thus, the same control platform can be used to perform a plurality of different operations on fluid in the microfluidic device. The microfluidic device may be placed in the plurality of different alignment positions in turn, with a different operation being performed on fluid in the microfluidic device at each alignment position.

The means for deforming the elastic layer may comprise means for applying force.

The control platform may comprise an external face that is coupleable to the elastic layer of the microfluidic device, and the means for applying force may be operable to apply force at least one part of the external face. The external face may be in contact with, or spaced apart from, the elastic layer of the microfluidic device.

The means for applying force may be operable to apply a force that has a component in a direction substantially perpendicular to the external face.

The means for applying force may be operable to apply force over an area, that area being larger than the area of the at least one part of the of the elastic layer at which deformation of the elastic layer causes operation of a microfluidic control component of the microfluidic device. Thus, it may be particularly straightforward to align the control platform and the microfluidic device, as it may be sufficient that the larger area over which force is applied covers the smaller area of the at least one part of the of the elastic layer at which deformation of the elastic layer causes operation of a microfluidic control component of the microfluidic device. That feature is particularly useful when the means for applying force is able to cause different amounts of deformation of the elastic layer across the area over which force is applied, for example when the means for applying force applies force using fluid pressure.

The means for deforming the elastic layer may comprise means for applying fluid pressure to the elastic layer.

The means for applying fluid pressure may be operable to apply pressure to one side of the elastic layer that is greater than or less than the pressure acting on the other side of the elastic layer. The applied pressure may be an over-pressure or an under-pressure, and may comprise an at least partial vacuum. The means for applying fluid pressure may be arranged to provide pressurised fluid in direct contact with the elastic layer.

The means for deforming the elastic layer may comprise a microactuator mechanism.

The elastic layer may form at least part of an external surface of the microfluidic device.

The system may further comprise alignment means for aligning the control platform and the microfluidic device. The alignment means may be configured to align the or a face of the control platform with the elastic layer.

The alignment means may be operable to align the control platform and the microfluidic device in the or an at least one alignment position.

The alignment means may be operable to align the means for deforming the elastic layer with the or an at least one selected part of the elastic layer.

The alignment means may be arranged to align the control platform and the microfluidic device so that the area over which the means for applying force is operable to apply force at least partially overlaps the at least one part of the of the elastic layer at which deformation of the elastic layer causes operation of a microfluidic control component of the microfluidic device.

The alignment means may be operable to align the face and elastic layer to be substantially parallel.

The alignment means may comprise at least one male element and at least one female element configured to receive the at least one male element.

The male element or at least one of the male elements may be provided on one of the microfluidic device and the control platform and the corresponding female element or a corresponding at least one of the female elements may be provided on the other of the microfluidic device and the control platform.

The alignment means comprises at least one alignment mark on each of the microfluidic device and the control platform.

The system may further comprise means for detachably coupling the control platform to the microfluidic device.

The coupling means may comprise means for forming a seal between at least part of the control platform and at least part of the elastic layer.

The means for deforming the elastic layer may comprise means for applying fluid pressure to the elastic layer, and the means for forming a seal may be arranged to form a seal around an area of the elastic layer so that fluid pressure is applied to the elastic layer over the sealed area.

The sealed area may comprise the or an at least one part of the of the elastic layer at which deformation of the elastic layer causes operation of a microfluidic control component of the microfluidic device.

The sealed area may be greater than the area of the or an at least one part of the of the elastic layer at which deformation of the elastic layer causes operation of a microfluidic control component of the microfluidic device.

The control platform may comprise the or a face that is coupleable to the elastic layer of the microfluidic layer, and the means for forming a seal may comprise at least one element that protrudes above the face of the control platform for engagement with the elastic layer.

The means for forming a seal may comprise an O-ring.

The coupling means may comprise fixing means for detachably fixing the microfluidic device to the control platform, for example at least one of a clamp, a screw, a bolt and a releasable adhesive.

The control platform may comprise at least one device for performing an operation on fluid in the microfluidic device.

The at least one device for performing an operation may comprise at least one sensor for sensing a property of fluid in the microfluidic device, or may comprise a device for altering a property of the fluid, for example a heater.

The system may further comprise biasing means for biasing away from the control platform the at least one device for performing an operation.

The biasing means may be arranged so that when the microfluidic device and the control platform are coupled such that the deforming means is operable to deform the elastic layer, the device for performing an operation on the fluid is biased towards the microfluidic device.

The biasing means may be arranged so that when the microfluidic device and the control platform are coupled such that the deforming means is operable to deform the elastic layer, the device for performing an operation on the fluid is biased to be in contact with the elastic layer. The biasing means may comprise at least one spring.

The system may further comprise a plurality of microfluidic devices each of which is coupleable to the control platform.

The system may comprise a plurality of control platforms, each of which is coupleable to the microfluidic device or to each of the microfluidic devices.

The system may further comprises means for controlling operation of the deforming means.

The elastic layer may form a wall of the fluid chamber or channel, and the fluid chamber or channel may comprise a further, opposing wall, and the control means may be operable to control the deforming means to deform the elastic layer towards the opposing wall. The control means may be operable to control the deforming means to deform the elastic layer to be in contact with the opposing wall.

The control means may be operable to successively deform different parts of the elastic layer in a sequence to perform a desired fluid operation.

The desired fluid operation may comprise at least one of pumping, mixing and allowing or preventing flow of the fluid.

The control means may be operable to repeatedly deform the or an at least part of the elastic layer thereby to perform a fluid operation.

In a further, independent aspect of the invention there is provided a microfluidic system comprising a microfluidic device comprising at least one fluid chamber or channel, wherein an elastic layer forms at least one wall of the at least one fluid chamber or channel; means for deforming the elastic layer; control means operable to control the deforming means to repeatedly deform the elastic layer thereby to perform an operation on fluid in the fluid chamber or channel.

The operation may comprise a mixing operation or a pumping operation.

The control means may be operable to control the rate of repetition of deformation of the elastic layer. The control means may thereby control the amplitude of deformation of the elastic layer and/or the rate of pumping or mixing.

The control means may be operable to control the rate of repetition of deformation of the elastic layer to be greater than a resonant frequency of vibration of the elastic layer.

In another independent aspect of the invention there is provided a detachable microfluidic control platform that is coupleable to a microfluidic device, wherein control platform comprises means for deforming an elastic layer of the microfluidic device thereby to manipulate fluid in at least one fluid chamber or channel of the microfluidic device.

The means for deforming the elastic layer may comprise means for applying force.

The control platform may comprise an external face that is coupleable to the elastic layer of the microfluidic device, and the means for applying force may be operable to apply force at least one part of the external face.

The means for applying force may be operable to apply a force that has a component in a direction substantially perpendicular to the external face.

The control platform may further comprise at least one device for performing an operation on fluid in the microfluidic device.

The control platform may further comprise biasing means for biasing away from the control platform the at least one device for performing an operation.

The control platform may further comprise means for controlling operation of the deforming means. The control means may be operable to successively deform different arts of the elastic layer in a sequence to perform a desired fluid operation. The control means may be operable to repeatedly deform the or an at least part of the elastic layer thereby to perform a fluid operation.

In another independent aspect of the invention there is provided a detachable microfluidic device comprising a rigid layer, an elastic layer and at least one fluid chamber or channel between the rigid layer and the elastic layer, configured so that deformation of the elastic layer manipulates fluid if present in the at least one fluid chamber or channel.

The detachable microfluidic device may be detachably coupleable to a control platform that is operable to deform the elastic layer.

The elastic layer may form at least part of an external surface of the microfluidic device. At least one part of the elastic layer may be deformable to cause operation of a microfluidic control component of the microfluidic device. The microfluidic control component may comprise a valve, mixer, or pump.

In another independent aspect of the invention there is provided a method of manipulating fluid in a microfluidic system comprising coupling to a control platform a detachable microfluidic device comprising a rigid layer, an elastic layer and at least one fluid chamber or channel between the rigid layer and the elastic layer, and deforming the elastic layer thereby to manipulate fluid in the at least one fluid chamber or channel.

In a further independent aspect of the invention there is provided a method of performing an operation on a fluid in at least one fluid chamber or channel of a microfluidic device, wherein an elastic layer forms at least one wall of the at least one fluid chamber or channel, the method comprising repeatedly deforming the elastic layer.

The method may comprise repeatedly deforming the elastic layer and controlling the rate of repetition of deformation of the elastic layer to be greater than a resonant frequency of vibration of the elastic layer.

In other independent aspects of the invention there may be provided a microfluidic device or system substantially as herein described with reference to the accompanying drawings, or a control platform substantially as herein described with reference to the accompanying drawings.

The invention may provide for the manipulation of fluids within microfluidic devices by means of micromechanical movements of a two-layer hybrid material, driven by a decoupled microscopic servomechanism. By a decoupled microscopic servomechanism may be meant a microscopic servomechanism that is not integrated into the two-layer hybrid material. The decoupled microscopic servomechanism may be coupleable to the two-layer material.

An integrated microfluidic system including a disposable microfluidic device and a microfluidic control plate may be provided. A decoupled control unit may be provided.

A system and manufacturing method for decoupled micromechanical manipulation and control of fluid flow and fluid dynamics in a microfluidic device may be provided.

The following features may be provided: 1.) two-layer hybrid microfluidic device combining a rigid polymer or other rigid layer and a deformable elastic membrane, therein to be used as a microvalve, and/or a micropump, and/or a micromixer, and 2.) decoupling of the microfluidic device from the microactuator mechanism.

The microactuator mechanism can be detached from the microfluidic chip, and the microactuator mechanism can instead be housed in a separate but aligned underlying control platform. Such a design can combine the use of low-cost, disposable microfluidic devices with a re-useable microactuator-based fluid control platform, giving the potential for use in a wide range of lab-on-a-chip applications.

Microfluidic flow control may be achieved through combined use of a two-layer hybrid microfluidic device and an array of microactuators on a control platform.

There may also be provided an apparatus or method substantially as described herein with reference to the accompanying drawings.

Any feature in one aspect of the invention may be applied to other aspects of the invention, in any appropriate combination. For example, apparatus features may be applied to method features and vice versa.

### DETAILED DESCRIPTION OF EMBODIMENTS

Embodiments of the invention are now described, by way of non-limiting example, and are illustrated in the following figures, in which:

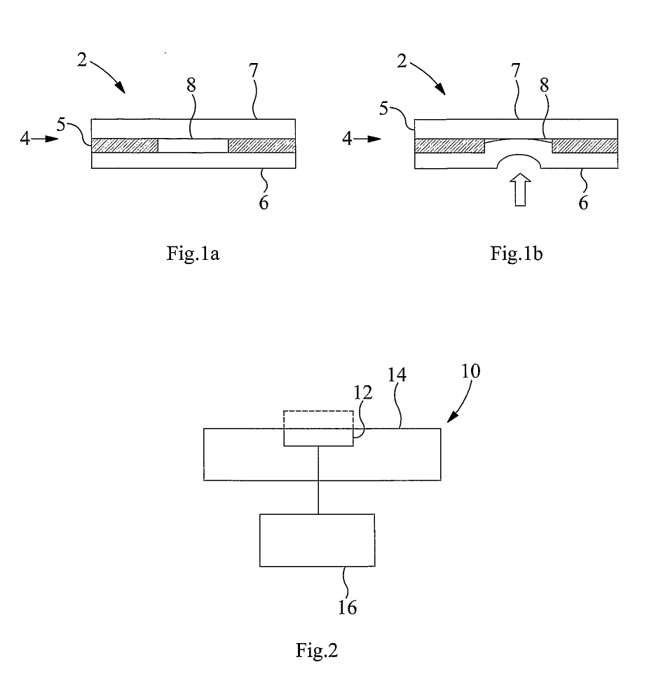

FIGS. 1a and 1b are schematic illustrations of a microfluidic device according to one embodiment;

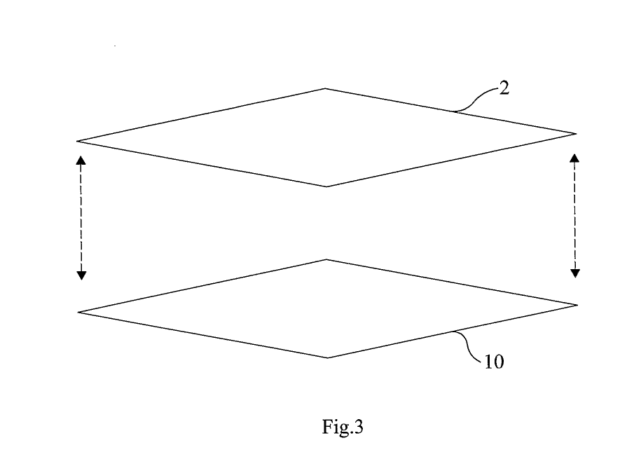

FIG. 2 is a schematic illustration of a control platform;

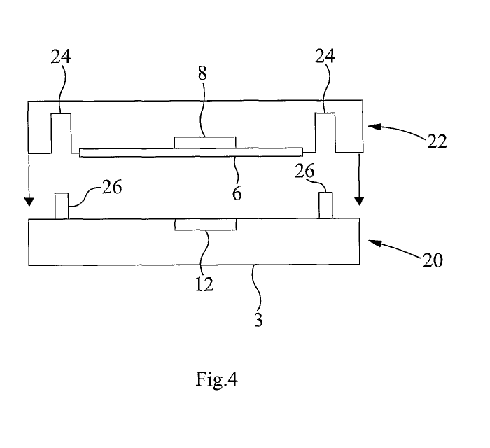

FIG. 3 is a schematic illustration, in perspective view, of the microfluidic device and the control platform;

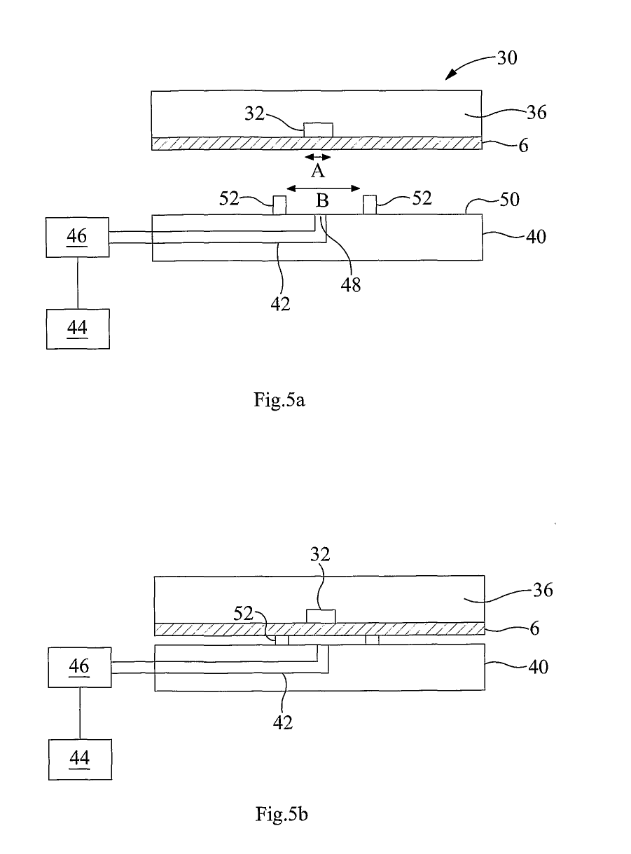

FIG. 4 is a schematic illustration of a microfluidic device and a control platform, which include alignment holes and pillars;

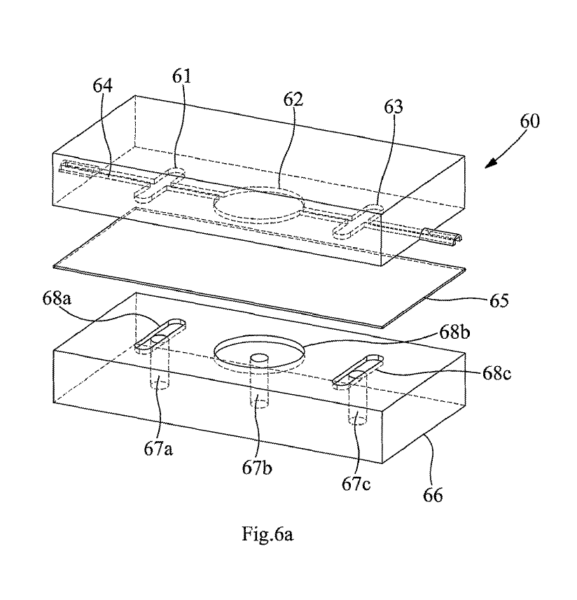

FIGS. 5a and 5b are schematic illustrations a microfluidic device and a control platform in a further embodiment;

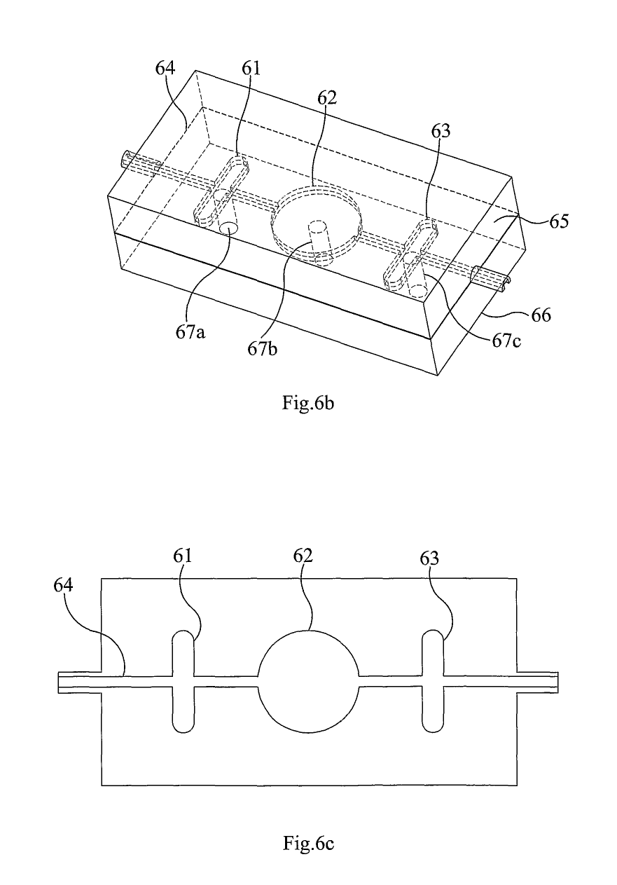

FIGS. 6a to 6c are schematic illustrations of a microfluidic device and a control platform according to a further embodiment;

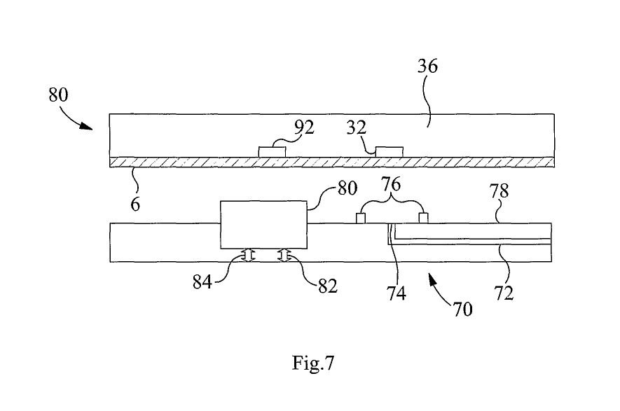

FIG. 7 is a schematic illustration of a microfluidic device and a control platform according to another embodiment;

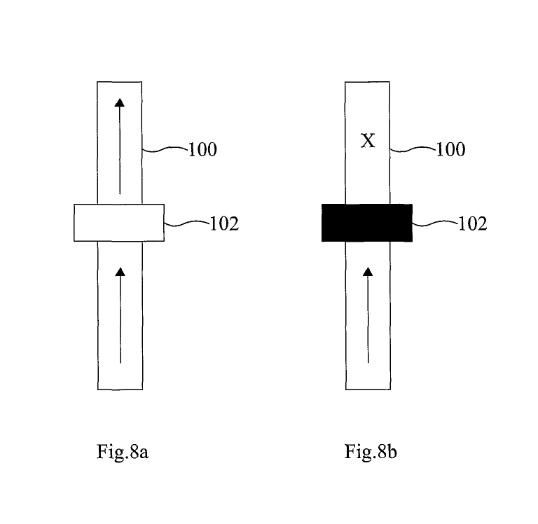

FIGS. 8a and 8b are schematic illustrations of a microfluidic valve;

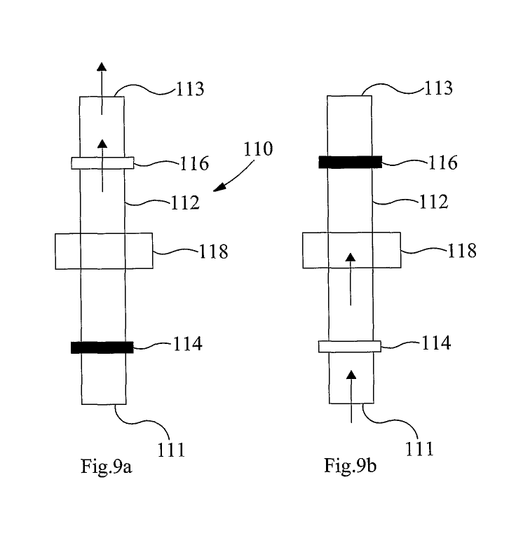

FIGS. 9a and 9b are schematic illustrations of a microfluidic pump or mixer; and

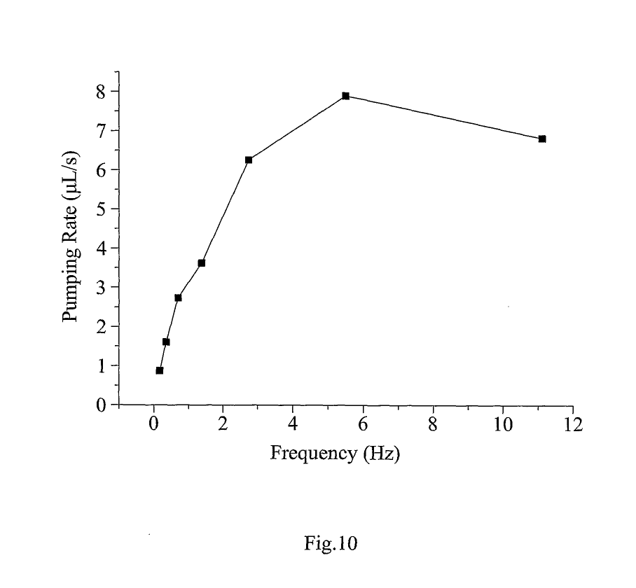

FIG. 10 is a graph of pumping rate as a function of actuator operation frequency for the microfluidic pump of FIGS. 8a and 8b.

FIGS. 1a and 1b show a microfluidic device 2 according to one embodiment. The microfluidic device 2 has a two layer structure comprising a first, rigid layer 4, and second deformable, elastic layer 6.

In the embodiment of FIGS. 1a and 1b, the rigid layer 4 is formed of lithographically patterned SU-8 polymer 5 spin coated on a glass substrate 7. The dimensions of the rigid layer are 1 mm (width) by 5 mm (length) by 100 μm (thickness), and the elastic layer is formed of a silicone film of thickness 100 μm.

The rigid layer 4 is fabricated to contain fluid flow chambers and/or channels. A single channel 8 of width 200 μm and depth 100 μm is shown in cross-section in FIGS. 1a and 1b.

The rigid and elastic layers have equivalent length and width, and are affixed together creating the two-layer device 2. First a layer of SU-8 resin is spin coated on the glass substrate 7. The thickness of the SU-8 can be precisely controlled by the spin rate. After the SU-8 is exposed to UV radiation through a mask, well-defined microstructures can be formed where the exposed area is cross-linked and unexposed area is washed away by solvent. A uniform layer of epoxy adhesive is then applied on the surface of the SU-8 resin, to which the elastic layer 6 is then adhered. Alternatively, oxygen plasma can be used to create a chemically reactive surface of the microfluidic device before elastic film is press bonded to the microfluidic device.

As shown in FIG. 1a, when no force is applied to the elastic layer 6, the elastic layer 6 is in its ‘at rest’ state and is planar, permitting fluid flow through the channel 8.

When force is applied to the elastic layer 6 in the region of the channel 8, the elastic layer 6 is deformed in the region of the channel 8, thereby affecting fluid flow in the channel 8. In the example of FIG. 1b, the force applied to the elastic layer 6 is sufficient to cause the elastic layer 6 to contact the opposing wall of the channel 8, thereby causing the channel 8 to close. Thus the application, or removal, of force to the elastic layer 6 in the region of the channel 8 can be used to cause a portion of the channel 8 to operate as a valve.

Although FIGS. 1a and 1b show a single channel that is operable as a valve, any desired number and arrangement of channels and/or chambers can be provided in the microfluidic device, and force can be selectively applied to deform any part of the elastic layer in order to control and/or otherwise manipulate fluid flow or fluid dynamics in the chambers or channels in any way that is desired.

It is a feature of the described embodiments that the microfluidic device is detachable from a control platform that can be used to apply force to the elastic layer in order to control fluid flow within the microfluidic device.

A control platform 10 is illustrated in FIG. 2. The control platform comprises a microactuator mechanism 12 disposed on a face 14 of the control platform 10. The microactuator mechanism is linked to a controller 16 that is operable to control operation of the microactuator mechanism 12. The microactuator mechanism is operable to move a micromechanical element (indicated by dotted lines in FIG. 2). When the face 14 of the control platform is engaged with the elastic layer 6 of the microfluidic device 2, operation of the microactuator mechanism 12 causes the micromechanical element to apply a force to, and thus deform, a corresponding portion of the elastic layer 6.

The controller is, for example, a general purpose computer programmed with suitable control and interfacing software, or may be a suitable dedicated hardware device, for example comprising one or more ASICs (application specific integrated circuits).

The part of the elastic layer 6 that is deformable by the microactuator mechanism 12 can be selected by aligning the microactuator mechanism 12 with the selected part of the elastic layer 6. In the example of FIGS. 1a and 1b, the microactuator mechanism 12 is aligned with the part of the elastic layer 6 that forms a wall of the channel 8 if it is desired to open or close the channel 8. Operation of the microactuator mechanism 12 then closes the channel 8. Subsequent deactivation, or removal, of the microactuator mechanism 12 relieves the elastic layer, returning the elastic layer to a planar form, and re-enabling fluid flow in the channel 8.

The microactuator mechanism 12 can be any electromechanical or electromagnetic device controllable by application of electrical current or magnetic field to move a micromechanical element to deform the elastic layer. Any suitable, known electromechanical or electromagnetic device may be used. Alternatively the microactuator mechanism may comprise a heating or cooling device that is operable to deform the elastic layer by selectively heating or cooling parts of the elastic layer. Alternatively, the microactuator mechanism may be operable to deform the elastic layer by applying fluid pressure, for example via a pneumatic or vacuum system. The microactuator mechanism may be formed of any suitable material, including (but not limited to) silicon, glass, ceramic, metal or polymer material.

In the embodiment of FIG. 2, the dimensions of the control platform 10 match the dimensions of the microfluidic device 2. The position of the microactuator mechanism 12 on the face of the control platform 10 corresponds to the position on the microfluidic device 2 of that part of the elastic layer 6 forming the wall of the channel 8. Thus, if the edges of the control platform 10 are aligned with the edges of the microfluidic device 2, as shown in FIG. 3, and the control platform 10 and the device 2 are brought together the microactuator mechanism 12 opposes that part of the elastic layer 6 forming the wall of the channel 8, and operation of the microactuator mechanism 12 opens or closes the channel 8. Thus, a simple technique for correctly aligning the control platform 10 and the microfluidic device 2 is provided. The rigid layer 4 gives the device 2 a well-defined shape, more easily enabling precise alignment with the underlying control platform 10.

Once the control platform 10 and the microfluidic device 2 have been aligned to a desired position and coupled together so that operation of the microactuator mechanism 12 causes deformation of the elastic layer 6, they are fixed together using screws that pass through fixing holes (not shown) in the microfluidic device 2 and are screwed into threaded holes (not shown) in the control platform 10. Any other suitable fixing arrangement can be used, for example a clamp, nuts and bolts, or releasable adhesive.

In the embodiment of FIGS. 2 and 3, the control platform 10 and the microfluidic device 2 can be aligned merely by aligning their edges. In alternative embodiments, further alignment features are provided. For example, a disposable microfluidic device 22 is shown in FIG. 4, which is provided with alignment holes 24. The control platform 20 comprises four precisely positioned alignment pillars 26 located at its corners, two of which are shown in FIG. 4. The microfluidic device 22 can be precisely aligned with the control platform 20 by inserting the alignment pillars 26 into the alignment holes 24. The disposable microfluidic device 22 can be easily plugged in to and thus correctly aligned with the control platform 20.

Various alternative alignment features are provided in different embodiments. For example, in some embodiments, various different positions of a microfluidic device on the control platform are used, depending on the operations to be performed on the microfluidic device and/or the type of microfluidic device to be coupled to the platform. In some such embodiments, alignment holes are provided on both the microfluidic device and the control platform, and different alignment positions can be selected by inserting pins between different pairs of alignment holes.

Although the use of alignment pillars or pins and alignment holes has been described, any type of male and female connectors can be used to align the microfluidic device and the control platform. Alternatively or additionally, alignment marks are provided on the control platform and the microfluidic device that are aligned when the control platform and the microfluidic device are in a correct position.

In the embodiment of FIG. 2, force is applied by the control platform to a part of the elastic layer of the microfluidic device by movement of a mechanical element driven by an electro-mechanical micro-actuator mechanism. As mentioned above, force can also be applied to deform the elastic layer by applying fluid pressure to the elastic layer, and an example of an embodiment that uses such application of fluid pressure is illustrated in FIGS. 5a and 5b. A microfluidic device 30 is shown in cross-section in FIG. 5a and comprises a fluid chamber 32 connected to a fluid channel, both formed within a rigid layer 36 of the microfluidic device 30. The elastic layer 6 forms a wall of the fluid chamber 32. The fluid channel runs in a direction perpendicular to the plane of the figure and is not shown in FIG. 5a.

A control platform 40 that is coupleable to the microfluidic device 30 for control of operation of the microfluidic device 30 is also shown in FIG. 5a. The control platform 40 comprises a fluid channel 42 that is connectable to a gas supply 44. The gas supply 44 is linked to a controller 46 that is operable to control the gas supply 44 to supply pressurised gas to the gas channel 42. An output 48 of the gas channel is provided in a face 50 of the control platform 40. An O-ring 52 is provided that is disposed on the face 50 around the output 48 of the gas channel. The controller 46 comprises at least one valve for controlling the supply of gas from the gas supply 44 and a suitable general purpose computer programmed with suitable control and interfacing software for controlling the at least one valve. The general purpose computer may be replaced by a suitable dedicated hardware device, for example comprising one or more ASICs (application specific integrated circuits).

In order to perform operations on the microfluidic device 30, the control platform 40 and the microfluidic device are aligned and fixed together as shown in FIG. 5b. The O-ring 52 is compressed between the face 50 of the control platform 40 and the elastic layer 6, and forms an air-tight connection that seals a volume connecting the output 48 of the gas channel and the part of the elastic layer 6 that covers the chamber 32.

In operation, pressurised gas is supplied by the gas supply 44 via the gas channel 42 to the sealed volume. The pressurised gas in the sealed volume applies a force to the elastic layer 6 over an area B defined by the O-ring. The pressurised gas causes the part of the elastic layer 6 forming a wall of the chamber 34, and having an area A, to deform and to cause fluid to flow from the chamber 34 into the channel. The chamber 34 and the channel form part of a microfluidic mixing device and, in operation, the controller 46 causes pressure to be applied and released from the sealed volume repeatedly in order to repeatedly deform and relax the elastic layer 6, thus contributing to a mixing of the fluid in the mixing device.

In variants of the embodiment of FIGS. 5a and 5b a vacuum, or under-pressure, rather than an over-pressure is applied to the elastic layer (for example, by pumping the sealed volume defined by the O-ring). In such embodiments, the elastic layer in its normal state can be in contact with the opposing wall of the chamber or channel and the application of the vacuum, or under-pressure, causes the elastic layer to move away from the opposing wall, opening the chamber or channel.

It is a feature of the embodiment of FIGS. 5a and 5b that the area A of the elastic layer that is deformable to cause operation of the microfluidic mixer (or other types of microfluidic control components, in other embodiments) is smaller than the area B over which force is applied to the elastic layer by the control platform 40. The use of pneumatics or other fluid pressurisation techniques to apply force to the elastic layer provides for greater tolerance in the alignment of the control platform and the microfluidic device, when the area over which force is applied is greater than the area of the elastic layer that is to be deformed to perform microfludic operations. In such embodiments, it is sufficient that the larger area over which force is applied covers, or at least overlaps, the smaller area that is to be deformed.

The microfluidic devices can be attached and detached from the control platform, and operations performed on the microfluidic devices, without having to change the set up of the control platform each time (the microfluidic devices and control platform can have a plug and use decoupled design). For example, for embodiments that use fluid pressurisation techniques, such as the embodiment of FIG. 5, the gas supply 44 and the controller 46 can remain connected to the control platform 50 whilst a series of microfluidic devices can be attached to and detached from the control platform 40. There is no need to reconnect gas or other inputs each time the microfluidic device on the control platform is changed.

The decoupled design means that it is relatively straightforward to perform measurements or operations on a series of microfluidic devices, using the same control components provided on the control platform. As the microfluidic devices have a simple structure, are relatively straightforward to manufacture, and do not need to include complex electromechanical devices, or sensors, they can be treated as disposable, if desired.

In some cases a series of measurements can be performed by the same control platform on microfluidic devices containing a series of different fluid samples or fluid samples under a series of different conditions. In one example, a series of measurements or operations can be performed on a series of different volumes of the same sample, by attaching a series of microfluidic devices in turn, each microfluidic device having a sample chamber of a different size. The embodiment of FIG. 5, for example, is suitable for performing such a series of measurements or operations, particularly if the area of the sample chamber in each case is smaller than the area over which the force is applied by the control platform (the area contained by the O-ring in FIG. 5).

The embodiments described in relation to FIGS. 1 to 5 include a microfluidic device having a single chamber or channel on which operations are performed by deforming the elastic layer, and a control platform having a single microactuator mechanism or other feature for applying force to the elastic layer. In practice many different chambers or channels can be included on the same microfluidic device, each of which can be used to perform microfluidic operations under control of a single control platform having multiple microactuator mechanisms or other devices for applying force, or performing measurements or other operations.

An embodiment with multiple channels, and multiple locations on the control platform that are used to apply force is illustrated in FIGS. 6a to 6c, and comprises a microfluidic device 60 made of Polymer SU-8 on a glass substrate, which contains three microfluidic chambers 61, 62, 63 linked by a channel 64 having channel dimensions 200 μm (width) by 5 cm (length) by 100 μm (thickness). The elastic layer 65 is formed of bonded silicone film of thickness 80 μm. The control plate 66 is made of a plastic material, PMMA, of dimensions 3 cm (width) by 5 cm (length) by 1 cm (thickness), and contains three pneumatic components each comprising an O-ring (not shown) and a gas channel 67a, 67b, 67c and output 68a, 68b, 68c that are operable to apply force to the elastic layer 65. The pressure or vacuum applied via the outputs 68a, 68b, 68c in operation causes deformation of the elastic layer 65, which can manipulate the fluid in the microfluidic device.

The control platform can also include various components to perform operations on the fluids in the microfluidic devices. The decoupled nature of the technology enables a high degree of flexibility in the control of reactions compared to existing microfluidic devices, allowing incorporation of any active micro-components for reaction control and/or monitoring into the control platform. This may include (but is not limited to) the integration of microheaters, micromagnets, microdiodes (UV or other), and micro-optical or other detectors or sensors to the control platform for use in any kind of applications, including biomedical applications.

This flexibility also extends to the fabrication of the microfluidic device. For example, a single type of microfluidic device may be built to perform all types of reactions on multiple different control platforms, each built for a different function. Alternatively, a single control platform can be used to perform all types of reactions on multiple different microfluidic devices (also referred to as chips), each built for a different function.

For some components, for example microheaters, micromagnets, and at least some types of sensor or detector, it can be important to have direct contact or at least a minimum distance between the component and the microfluidic device, in order for the component to perform its function correctly on the fluid within the microfluidic device.

Contact, or at least a sufficiently small gap, between components of the control platform and the microfluidic device can be provided by mounting the components on the control platform with springs, elastic cushioning material or other biasing elements for ensuring that the components protrude above the face of the control platform. That can be particularly important for embodiments in which fluid pressure is used to apply force, and in which an O-ring or other sealing mechanism is used to create a seal between the face of the control platform and the microfluidic device, as O-rings or other sealing mechanisms are usually of non-negligible thickness and leave a gap between the control platform and the microfludic device.

An example of such an embodiment is illustrated in cross-section in FIG. 7, which shows a control platform 70 for use with a microfluidic device 90. The microfluidic device is similar to that illustrated in FIGS. 5a and 5b, but includes a further chamber 92 connected to a further fluid channel. The channel and the further channel run in a direction perpendicular to the plane of the figure and are not shown in FIG. 7. The control platform 70 comprises a pressurised gas channel 72 and output 74 for applying pressure to the elastic layer 6 when coupled to the microfluidic device 30. An O-ring 76 is provided to form a seal between the elastic layer 6 and the face 78 of the control platform 70 around the output 74. The control platform also includes a further component, in this case a microheater 80 that can be aligned with, and heat fluid in, the further chamber 92. The microheater 80 is mounted on springs 82, 84. The springs 82, 84 bias the microheater 80 away from the face of the control platform 70. It can be seen from FIG. 7 that when the face of the control platform and the elastic layer of the microfluidic device are not in contact, the microheater protrudes from the face of the control platform above the level of the O-ring 76.

When the face of the control platform and the elastic layer, or other surface, of the microfluidic device are clamped or otherwise joined together, the microheater component 80 is contacted by the elastic layer 6 and is at least partially pushed into the body of the control platform until the elastic layer contacts and is sealed against the O-ring 76. Good contact is maintained between the microheater component 80 and the elastic layer 6 by the biasing effect of the springs 82, 84.

As has already been mentioned, the deforming of the elastic layer of the microfluidic device in the region of one or more fluid channels or chambers can cause the fluid channels or chambers to operate as microfluidic control components, for example valves, mixers or pumps.

The operation of a fluid channel as a valve has already been described in relation to FIG. 1. A further embodiment in which a fluid channel is operated as a valve is illustrated in FIGS. 8a and 8b, which shows in a planar view a fluid flow channel 100 of dimensions 1 mm (width) by 5 mm (length) by 100 μm (thickness) formed in a glass substrate, and that comprises a microvalve region 102. The glass substrate is covered with an elastic layer formed of SU-8 material, which forms a wall of the fluid flow channel 100. Fluid flow through the channel 100 in the microfluidic device is controlled using the microvalve region 102. Fluid can flow through the channel 100 when the microvalve region 102 of the channel is open (the microactuator mechanism of the control platform is not applied to the elastic layer, elastic layer is planar) as indicated schematically in FIG. 8a. Fluid flow through the channel is stopped as indicated schematically in FIG. 8b when the microvalve region 102 of the channel 100 is closed (the microactuator mechanism is applied to the elastic layer in the microvalve region 102, elastic layer is deformed, blocking the channel).

A micropump component can be also be formed, and uses a similar mechanism to the microvalve, based upon the application of force to deform the elastic layer so that it is forced into a fluid flow channel or chamber in the rigid layer of the microfluidic device. However, in a micropump the deformation of the elastic layer may be such as to not completely close the channel or chamber and thus not to preclude fluid flow through the channel or channel. Instead the deformation of the elastic layer of the micropump component forces the fluid to flow through or out of the channel in one or more directions.

FIGS. 9a and 9b illustrate schematically the operation of a micropump arrangement 110 implemented using a decoupled two-layer microfluidic device. The micropump arrangement 110 represented schematically in planar view in FIGS. 9a and 9b comprises a microfluidic device comprising a fluid flow channel 112 of dimensions 1 mm (width) by 15 mm (length) by 100 μm (thickness) formed in a glass substrate, and having an opening 111, 113 at each end. The fluid flow channel 112 comprises two microvalve regions 114, 116 flanking a micropump region 118 in which the fluid flow channel 112 widens to form a circular microchamber of dimensions 5 mm (diameter) and 100 μm (depth). The glass substrate is covered with an elastic layer in the form of a membrane of SU-8 material, that forms a wall of the fluid flow channel.

The microfluidic device illustrated in FIGS. 6a to 6c has a geometry that is suitable for use in the micropump arrangement of FIGS. 9a and 9b.

The microfluidic device is aligned with and coupled to a control platform, such that microactuator mechanisms of the control platform are aligned with and individually operable to deform the elastic membrane at the two microvalve regions 114, 116 and at the micropump region 118.

In order to perform a pumping operation, the control platform repeatedly operates the microactuator mechanisms in a predetermined sequence. In the first stage of sequence, the microactuator mechanism adjacent to the first microvalve 114 is activated to close the first microvalve 114, whereas the second microvalve 116 remains open. The microactuator mechanism adjacent to the micropump region 118 is then activated to force fluid out of the microchamber. As the first microvalve 114 is closed, the fluid is forced along the channel 112 towards and through the second valve 116.

In the next stage of the sequence, the microactuator mechanism adjacent to the first microvalve 114 is de-activated to open the first microvalve 114, and the microactuator mechanism adjacent to the second valve is activated to close the second microvalve 116 (the microactuator mechanism adjacent to the microchamber remains activated during those operations).

The microactuator mechanism adjacent to the microchamber is then deactivated, releasing the elastic membrane adjacent at that location and pulling fluid through the opening 111 to the channel 112, and towards and through the first microvalve 114 and the microchamber, in the direction of the (now-closed) second microvalve 116.

The sequence is then repeated, to pump fluid through the channel 112 in a controlled fashion. Performing the sequence of operations in reverse pumps fluid through the channel 112 in the opposite direction.

The size of the microchamber and/or the fluid flow channel 112 can be varied in order to vary the pumping rate or other properties of the pump. For example, in variants of the embodiment of FIGS. 9a and 9b, the diameter of the microchamber varies between 0.05 mm and 5 mm in diameter.

It has been found that the pumping rate of the pump can also be varied by varying the frequency at which the sequence of stages is repeated (and thus the frequency at which the elastic membrane is deformed and allowed to relax). A graph of pumping rate as a function of frequency of operation (equal to the frequency of activation of the microactuator mechanism adjacent to the microchamber of the micropump in this case) is provided in FIG. 10. The flow rate is proportional to frequency until the frequency reaches the resonant frequency of the membrane. When the actuation frequency greater than the resonant frequency of the elastic membrane in the region of the microchamber, the maximum amplitude of deformation of the elastic membrane is not fully achieved. Therefore, the pumping volume is reduced upon further increase of the actuation frequency.

The repeated deformation of the elastic layer can also be used to provide mixing effects. In one example, the micropump of FIG. 9 can be operated as a mixer. The opening 111 of the fluid flow channel 112 is connected to one source of fluid, and the other opening 113 is connected to another source of fluid, and the fluids from the two sources are allowed to pass to the microchamber. The microactuator mechanisms are then operated to close the microvalves 114, 116. With the microvalves 114, 116 closed, the microactuator mechanism adjacent to the microchamber is then repeatedly activated at a frequency (for example, greater than 100 Hz) much higher than the resonant frequency of that part of the elastic membrane forming a wall of the microchamber (for example, the resonant frequency in the embodiment of FIG. 9 is around 10 Hz). By operating at such a frequency, the elastic layer is deformed with an amplitude (for example 5 microns) that may be smaller than the amplitude obtainable if operating at a frequency lower than the natural frequency, but that is sufficient to induce mechanical disturbance in the fluids to mix the fluids inside the microchamber. The fluids may be both be liquids, or at least one of the fluids may be a gas.

In another arrangement, a microchamber is used as a mixing chamber by repeatedly deforming the elastic layer forming a wall of the mixing chamber, as described in the preceding paragraph, but instead of the fluid being constrained to the mixing chamber by the closure of valves on both sides of the mixing chamber (for example microvalves 114, 116 described in the preceding paragraph) the microchamber is connected to an open fluid flow channel on each side and the fluid is mixed as it flows through the microchamber.

In another arrangement, each end 111, 113 of the fluid flow channel is connected to a respective microchamber. In that arrangement, the micropump is operated to alternately pump the fluids to be mixed between the microchambers in one direction and then in the reverse direction. It has been found that repeating the pumping operation in one direction and in the reverse direction more than once is sufficient to mix two fluids.

The microfluidic control components described in relation to FIGS. 8 and 9 may also be implemented in integrated microfluidic structures that comprise both fluid channels and/or chambers and components for manipulating the fluid in the channels and/or chambers. The microfluidic control components do not have to implemented in a decoupled structure such as those described in relation to FIGS. 1 to 7, in which a control platform is coupleable and decoupleable from a microfluidic device.

Various materials for use as the elastic layer have been described, but the elastic layer is not limited to being formed of such materials. Any suitable material can be used for the elastic layer, for example silicone, polyurethane elastomer, butyl rubber, nitrile rubber, ethylene acrylic elastomer, ethylene propylene rubber, natural rubber, styrene containing block copolymer elastomers, santoprene elastomer and polychroroprene elastomer. The elastic layer can be of any suitable thickness, and the most appropriate thickness may depend on the microfludic operations to be performed and on the size and arrangement of the microfluidic chambers and channels. For the embodiments illustrated in FIGS. 1 to 10, it has been found that it is desirable for the elastic layer to have a thickness less than or equal to 250 μm.

The embodiments described in relation to FIGS. 1 to 7 have included a rigid layer that is substantially rigid in its entirety. In alternative embodiments, the rigid layer comprises a substantially rigid framework and flexible or other material attached to the substantially rigid framework.

The microfluidic control platform can be formed of any suitable material, and is usually formed of a rigid material, for example glass, plastic, polymer or ceramic.

The microfluidic systems can be used for manipulation of or operations on microfluidic amounts of fluids, either gases or liquids, for any purpose. Any type of sample may be manipulated or operated on using the systems. Examples of samples include but are not limited to: particulate matter including nano-particles, quantum dots, polymer or magnetic beads; organisms; organs; tissues (such as tumour biopsies and blood vessels); cell samples, samples of cell derived parts or substances, any cells or eukaryotic or prokaryotic origin such as primary cell cultures, stem cells and cell lines, and including animal, plant, yeast and bacterial cultures. The samples may be samples for a biological or biochemical assay such as, for example, blood, urine, saliva, cell derived part or substance (such as proteins, genes, genomes, DNA, RNA, organelles such as mitochondria or ribosome, or cell or organelle membranes).

Certain embodiments may eliminate the need to integrate microactuator components onto a microfluidic device, making device fabrication and investigation significantly less complex than existing systems, therefore lowering manufacturing costs, increasing the potential for high value manufacture, and also contributing to the disposability of microfluidic devices.

Certain embodiments open the possibility of modular microfluidic device fabrication, giving the potential to easily change and assemble custom microfluidic systems for different applications, as determined by an end user.

It will be understood that the present invention has been described above purely by way of example, and modifications of detail can be made within the scope of the invention.

Each feature disclosed in the description, and (where appropriate) the claims and drawings may be provided independently or in any appropriate combination.

We claim:

1. A microfluidic system comprising: a detachable microfluidic device comprising a rigid layer, an elastic layer and at least one fluid chamber or channel between the rigid layer and the elastic layer; and
a control platform comprising means for deforming the elastic layer thereby to manipulate fluid in the at least one fluid chamber or channel.

2. A system according to claim 1, wherein the microfluidic device and the detachable control platform are coupleable in at least one alignment position, in which the means for deforming the elastic layer is operable to selectively deform at least one selected part of the elastic layer.

3. A system according to claim 2, wherein the at least one selected part of the elastic layer comprises at least one part of the elastic layer at which deformation of the elastic layer causes operation of a microfluidic control component of the microfluidic device.

4. (canceled)

5. A system according to claim 2, wherein the microfluidic device and the control platform are coupleable in a plurality of different alignment positions, and in each alignment position deformation of the elastic layer causes operation of a respective at least one microfluidic control component of the microfluidic device.

6. A system according to claim 1, wherein the means for deforming the elastic layer comprises means for applying force.

7. A system according to claim 6, wherein the control platform comprises an external face that is coupleable to the elastic layer of the microfluidic device, and the means for applying force is operable to apply force at least one part of the external face, for example over an area, that area being larger than the area of the at least one part of the of the elastic layer at which deformation of the elastic layer causes operation of a microfluidic control component of the microfluidic device.

8-9. (canceled)

10. A system according to claim 1, wherein the means for deforming the elastic layer comprises one of: a means for applying fluid pressure to the elastic layer; a microactuator mechanism.

11-12. (canceled)

13. A system according to claim 1, further comprising alignment means for aligning the control platform and the microfluidic device.

14-17. (canceled)

18. A system according to claim 1, further comprising means for detachably coupling the control platform to the microfluidic device, wherein optionally the coupling means comprises means for forming a seal between at least part of the control platform and at least part of the elastic layer.

19. (canceled)

20. A system according to claim 18, wherein the means for deforming the elastic layer comprises means for applying fluid pressure to the elastic layer, and the means for forming a seal is arranged to form a seal around an area of the elastic layer so that fluid pressure is applied to the elastic layer over the sealed area.

21. A system according to claim 20, wherein the sealed area comprises the or an at least one part of the of the elastic layer at which deformation of the elastic layer causes operation of a microfluidic control component of the microfluidic device, and the sealed area is greater than the area of said at least one part of the of the elastic layer at which deformation of the elastic layer causes operation of a microfluidic control component of the microfluidic device.

22. (canceled)

23. A system according to claim 1, wherein the control platform comprises the or a face that is coupleable to the elastic layer of the microfluidic layer, and the means for forming a seal comprises at least one element that protrudes above the face of the control platform for engagement with the elastic layer, and optionally the means for forming a seal comprises an O-ring.

24-25. (canceled)

26. A system according to claim 1, wherein the control platform comprises at least one device for performing an operation on fluid in the microfluidic device, wherein optionally the at least one device for performing an operation comprises at least one sensor for sensing a property of fluid in the microfluidic device.

27. (canceled)

28. A system according to claim 26, further comprising biasing means for biasing away from the control platform the at least one device for performing an operation, wherein optionally the biasing means is arranged so that when the microfluidic device and the control platform are coupled such that the deforming means is operable to deform the elastic layer, the device for performing an operation on the fluid is biased towards the microfluidic device.

29-31. (canceled)

32. A system according to claim 1, further comprising means for controlling operation of the deforming means, wherein optionally the control means is operable to successively deform different parts of the elastic layer in a sequence to perform a desired fluid operation, and the desired fluid operation may comprise at least one of pumping, mixing and allowing or preventing flow of the fluid.

33-34. (canceled)

35. A system according to any of claim 32, wherein the control means is operable to repeatedly deform the or an at least part of the elastic layer thereby to perform a fluid operation, and optionally the control means is operable to control the rate of repetition of deformation of the elastic layer to be greater than a resonant frequency of vibration of the elastic layer.

36-39. (canceled)

40. A detachable microfluidic control platform that is coupleable to a microfluidic device, wherein the control platform comprises means for deforming an elastic layer of the microfluidic device thereby to manipulate fluid in at least one fluid chamber or channel of the microfluidic device.

41-43. (canceled)

44. A control platform according to claim 40, further comprising at least one device for performing an operation on fluid in the microfluidic device, and optionally further comprising biasing means for biasing away from the control platform the at least one device for performing an operation.

45-48. (canceled)

49. A detachable microfluidic device comprising a rigid layer, an elastic layer and at least one fluid chamber or channel between the rigid layer and the elastic layer, configured so that deformation of the elastic layer manipulates fluid if present in the at least one fluid chamber or channel.

50-53. (canceled)

54. A method of manipulating fluid in a microfluidic system comprising coupling to a control platform a detachable microfluidic device comprising a rigid layer, an elastic layer and at least one fluid chamber or channel between the rigid layer and the elastic layer, and deforming the elastic layer thereby to manipulate fluid in the at least one fluid chamber or channel.

55-58. (canceled)
